(19) United States
(12) Patent Application Publication
(10) Pub. No.: US 2011/0116199 A1
(43) Pub. Date: May 19, 2011

(54) Power Dampener for a Fault Current Limiter

(76) Inventor: Francis Anthony Darmann, New South Wales (AU)

(21) Appl. No.: 12/674,770

(22) PCT Filed: Aug. 30, 2007
(86) PCT No.: PCT/AU07/01251

§ 371 Date: Feb. 23, 2010

(51) Int. Cl. H02H 3/22

(52) U.S. Cl. 361/111

(57) ABSTRACT

A method of dampening a transient in a DC biasing coil in a fault current limiter, the method including the step of: interconnecting a transient suppression circuit across the DC biasing coil, the transient suppression circuit being operative when the transient voltage across the DC biasing coil exceeds a predetermined maximum.

### FIELD OF THE INVENTION

The present invention relates to superconducting fault current limiter devices.

### BACKGROUND

The utilization of superconducting fault current limiters is well known as having an enormous potential in protecting electrical circuits from phase to phase faults and phase to ground faults.

Examples of superconducting fault current limiting devices can be seen in: U.S. Pat. No. 7,193,825 to Darmann et al; U.S. Pat. No. 6,809,910 to Yuan et al; U.S. Pat. No. 5,726,848 to Boenig; and US Patent Application Publication Number 2002/0018327 to Walker et al. Taking the example of Darmann, these devices may operate by means of a DC biasing coil being placed around a magnetic core to bias the core into magnetic saturation. Upon the occurrence of a fault, the core is taken out of saturation which induces a substantial reluctance to the fault. Other current limiting devices often utilize the manipulation of the magnetic properties of a core.

During operation of most fault current limiting devices, substantial current fault may pass through the AC circuit of the device when a fault event occurs. This induces a corresponding transient voltage and current into the DC circuit of the device. The superconducting coil itself, inter-connections, cryostat feedthroughs, the DC power supply, and the power supply filtering (e.g. capacitors), and protection devices (For example, Diodes, Transistors) must be selected or designed to withstand the worst case magnitude of the expected transient voltage, current, and net energy transferred during the transient period.

A fault event in the context of this description can be described on one form as a short circuit on the AC circuit that is being protected by the FCL—that is a short circuit or other transient phenomenon on the AC circuit for which the FCL was designed to limit. The fault event is assumed to not describe an internal fault developed within the FCL, the windings, or its components.

An example of this problem is illustrated in FIG. 1 and FIG. 2 which illustrate the simulation of a fault event on an aforementioned device due to Darmann. In FIG. 1 there is illustrated a time voltage graph of a simulated fault occurring at t=4.000 seconds. In FIG. 2 there is illustrated a corresponding induced current flow in a DC superconducting biasing coil. It can be seen that there is a large potentially damaging induced current at time t=4.000 seconds and beyond. The simulation results show a 500V transient voltage can be induced with over 1.1 kA of peak current. Such transients may damage the DC power supply to the coil and the DC coil itself.

It is difficult to reduce this transient induced current because it is effectively driven by the transformer effect between the AC and the DC coils and is hence a function of the fault current which is system dependent. It can be reduced if the AC side voltage is reduced but that is fixed and application dependent (for example: 11 kV, 22 kV etc).

The transient induced current may also be reduced by lowering the turns ratio between the DC and AC side—this requires increasing the number of turns on the DC coil which may be impractical for the fault limiting percentage required in the application under consideration or it may too expensive. Alternatively, the number of turns on the AC side may be reduced, however, this will reduce the effective impedance of the device for limiting fault currents. The transient impedance of the device is proportional to the square of the number of AC turns. Reducing the effective impedance through lowering the number of AC turns is a disadvantage because to compensate for this, the cross sectional area of steel would have to be increased making the design larger, heavier, and more expensive.

In addition, it must be noted that during the steady state operation of the device, an induced current and voltage is also present in the DC circuit as a result of the induction from the AC side. These are far lower in magnitude than those induced during the fault current limiting event, but nevertheless, this effect must be allowed for in the design of the DC coil power supply interface circuit, For example, by providing sufficient capacitance to ground to sink the current away from the DC power supply.

It is common in superconducting applications to include a quench detection circuit and protection. The quench circuit usually consists of a rapidly opening solid state switch to isolate the power supply and another solid state switch which closes to dump the stored energy into a resistor. These so called “quench protection mechanisms” are design to protect the superconducting coil from internally developed faults or unstable thermal transients which drive the coil into a normally conductive state. Quench detection circuits often rely on the detection of a ratio of voltages between two or more coil sections developed internally to the superconducting coil.

Unfortunately, a quench detection circuit and protection mechanism circuit are not suitable to dump the energy during a fault event on the AC circuit in a DC saturated fault current limiter. This is because a voltage ratio detection circuit will not function correctly. The voltage transient phenomenon induced into the DC circuit during a fault on the AC side is not due to an internally developed fault.

Furthermore, and as a result of the phenomenon discussed in the above points, the voltage transients induced are evenly distributed across the coil—this does not lend it self to traditional quench detection and protection

Any discussion of the prior art throughout the specification should in no way be considered as an admission that such prior art is widely known or forms part of the common general knowledge in the field.

### SUMMARY

It is an object of the present invention to provide an effective method of power dampening of transients in a fault current limiter.

In accordance with a first aspect of the present invention, there is provided a method of dampening a transient in a DC biasing coil in a fault current limiter, the method including the step of interconnecting a transient suppression circuit across the DC biasing coil, the transient suppression circuit being operative when the transient voltage across the DC biasing coil exceeds a predetermined maximum.

The transient suppression circuit can include a first and second series of diodes connected in series, with the first and second series being connected in parallel with an opposite orientation to one another. Alternatively, the transient suppression circuit can include a series of cascaded Zener diodes. Alternatively, the transient suppression circuit preferably can include a series of non-linear resistors. The DC biasing coil can be wrapped around a core of a single phase or multiple phases in a multiphase system. The DC biasing coil can comprise a superconducting coil.

In accordance with a further aspect of the present invention, there is provided a power dampening circuit for interconnection in parallel with a DC biasing coil in a fault current limiter, the power dampening circuit having a non-linear response, having a high impedance to low voltages across the DC biasing coil and a low impedance to high voltages across the DC biasing coil.

The circuit can be formed from passive components, including a series of Zener diodes connected in series and activated when a predetermined voltage across the DC coil can be exceeded or at least one non-linear resistor.

### BRIEF DESCRIPTION OF THE DRAWINGS

A preferred embodiment of the invention will now be described, by way of example only, with reference to the accompanying drawings in which:

FIG. 1 illustrates a graph of the calculated induced EMF in a DC coil of the prior art upon the occurrence of a fault condition;

FIG. 2 illustrates a graph of the calculated induced current within a DC coil of a fault current limiter when subjected to a simulated fault condition;

FIG. 3 shows one arm of a fault current limiter constructed in accordance with U.S. Pat. No. 7,193,825;

FIG. 4 shows a circuit for simulation of a DC saturated FCL without protection against reflected power;

FIG. 5 shows a plot of the simulated response for the circuit of FIG. 4;

FIG. 6 shows a plot of the reduction of fault current due to operation of the FCL in FIG. 4;

FIG. 7 illustrates schematically the connection of a power dampening circuit in parallel with the DC coil;

FIG. 8 illustrates schematically one form of dampening circuit;

FIG. 9 illustrates a second form of dampening circuit;

FIG. 10 illustrates a simulated circuit including the dampening circuit of FIG. 8;

FIG. 11 illustrates the corresponding DC transients for the circuit of FIG. 10;

FIG. 12 illustrates a graph showing the reduction in fault current through the utilization of the power dampener;

FIG. 13 illustrates a graph showing the operation of a DC circuit transient;

FIG. 14 illustrates the DC circuit current for two consecutive transients; and

FIG. 15 illustrates the DC circuit current for two closely spaced consecutive transients.

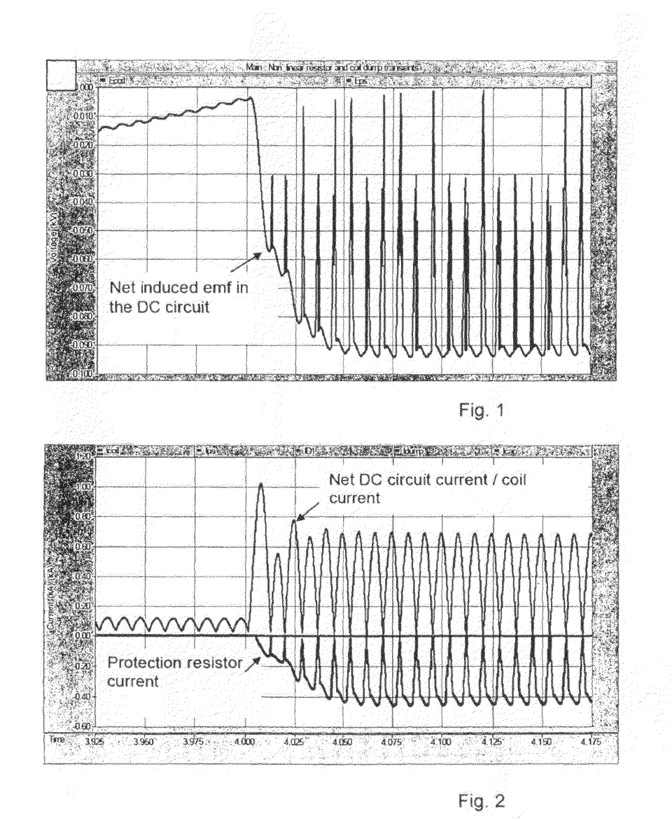

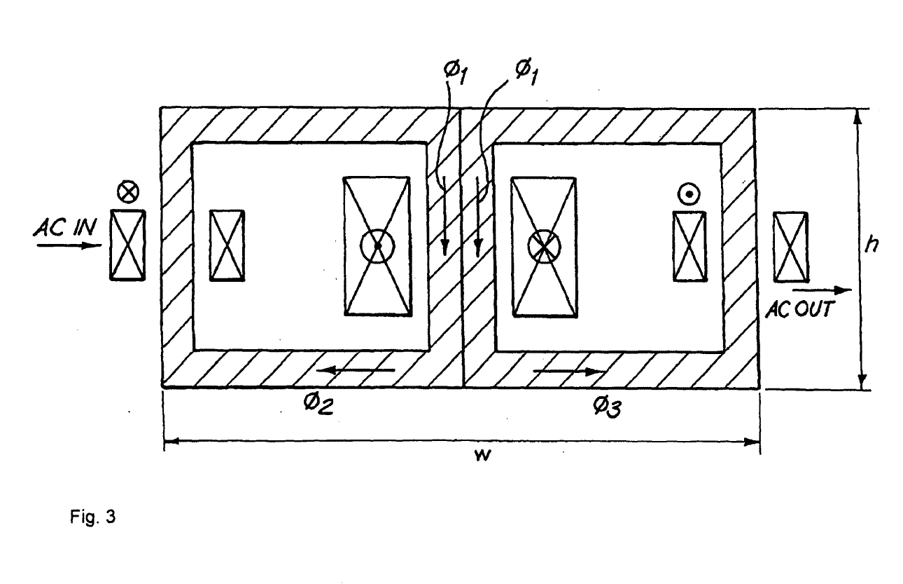

### DETAILED DESCRIPTION

In the preferred embodiments, it is recognised that the energy in a DC saturated superconducting coil surrounding an iron core is substantially equal to the product of the magnetic field and the magnetisation because the core is in a highly saturated state. A highly saturated core is desired to minimise the insertion impedance of the device (i.e. the impedance of the device seen at the AC terminals in the non-faulted, steady state condition). In a DC saturated FCL, such as that disclosed in U.S. Pat. No. 7,193,825 (the contents of which arc hereby incorporated by cross reference), both an AC and DC coil are present. The energy that must be dumped during a fault current event (i.e. a short circuit on the AC circuit being protected) includes not only the stored energy of the DC coil, but also the energy reflected into the DC coil from the AC circuit due to the mutual coupling between the AC and DC coils. This energy can be represented as follows:

$$Energy = B ( to ) \cdot H ( to ) + {\int }_{to}^{t 1} v ( t ) \cdot i ( t ) \cdot d t \qquad Eqn 1$$

Where: Energy is the total energy dissipated in the DC circuit, B(to) is the DC Magnetic field in the steel core before the time of the fault; H(to) is the DC magnetisation of the steel core before the time of the fault; V(t) is the voltage transient induced into the DC coil from the AC coupling; i(t) is the current transient induced into the DC coil from the AC coupling; and t1 is the end of the fault period in the AC circuit.

The transient voltage and current in the DC coil will depend on the features of the protection circuit and the DC coil. In the preferred embodiments it is desired to reduce the magnitude of both v(t) and i(t) and to manage the total coil energy so that it is safely dumped in an external resistor during operation of the FCL (i.e. during a fault on the AC circuit).

The first part of the energy equation (Eqn. 1) is a quantity which depends on the specific design of the DC saturated FCL. The values of B and H are normally optimised according to technical and economical considerations. The second part of the energy equation is augmentable through judicious design of the turns ratio between the AC and DC circuits and the degree of coupling between them. Lower magnetic coupling, for example through the introduction of an air gap in the steel core, will reduce the induced transient current and voltages, however, this increases the number of superconducting ampere-turns required to saturate the core and this may be uneconomic.

In addition, the magnetising field, is increased increasing the DC stored energy in the system. Those skilled in the art will recognise that the additional energy is substantially stored in the magnetic field of the air gap volume.

A better way to reduce the total energy is to directly reduce the energy coupled into the DC circuit from the AC circuit by controlling the transient induced current and voltage waveforms, v(t), and i(t), through protection circuitry on the DC circuit. Placing a suitably sized resistor in parallel across the DC coil can achieve this aim, however, with a permanently connected resistor, there will be significant power losses and the DC power supply must be sized considerably larger to supply the constant DC shunt current.

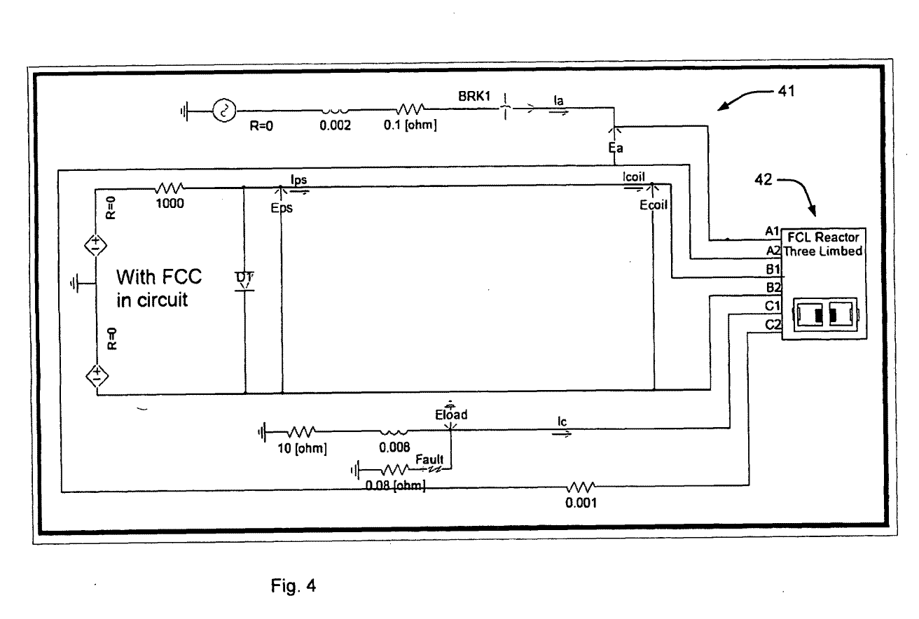

FIG. 4 illustrates a simulated AC circuit used to simulate tests on the preferred embodiment. The circuit 41 is interconnected to a three limb FCL 42 as formed in the aforementioned patent application. The saturation magnetic field was 2.00 Tesla and the magnetisation is 10,000 A/m. The energy stored in the DC magnetic field is approximately 20 kJ. In simulation, there are many different methods of representing a DC power supply. Substantially consistent results were found to be obtained whether employing a constant current source model, a constant voltage source model, a linear regulated power supply model, or a switched mode power supply. The details of the transient voltage and current waveforms induced in each case varied but this did not appear to detract from the operation of the protection mechanisms herein disclosed. For simplicity, the simulations of the preferred embodiment employed a constant voltage source.

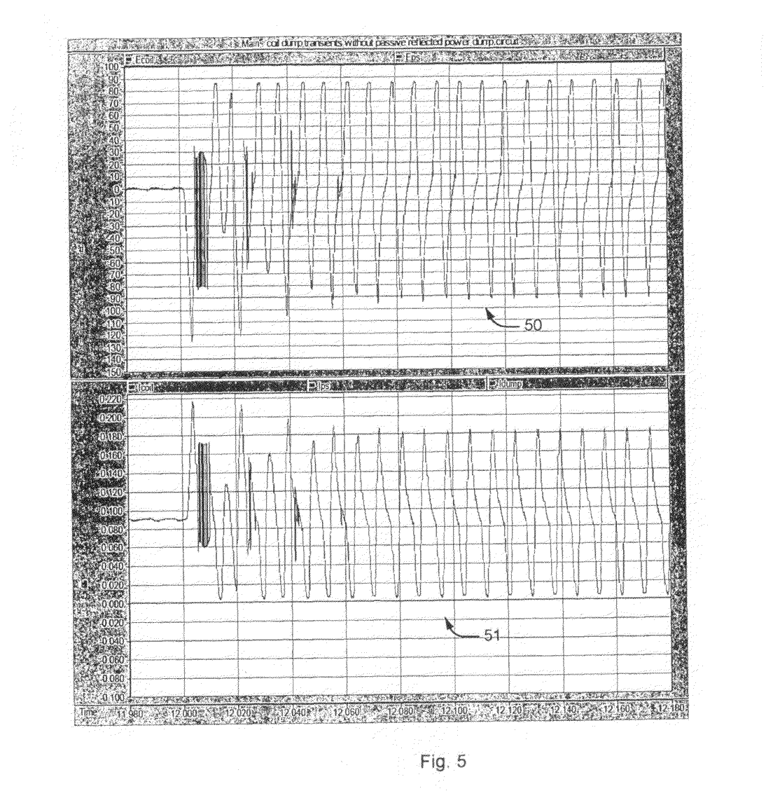

FIG. 5 illustrates a graph of the prospective induced current and voltage transient waveform responses in the DC circuit to a fault on the AC side. The AC circuit fault is simulated by introducing a short circuit to a 0.08 Ohm resistor. The plot 50 illustrates the AC circuit fault, whereas the plot 51 illustrates the corresponding induced transient voltage in the DC circuit. The induced transient is large due to a lack of any resistance and will depend on the details of the DC power supply. In general, the transient induced voltage into the DC circuit 51 is detrimental to the superconducting coil and could cause incremental insulation damage and a complete failure of the superconducting coil.

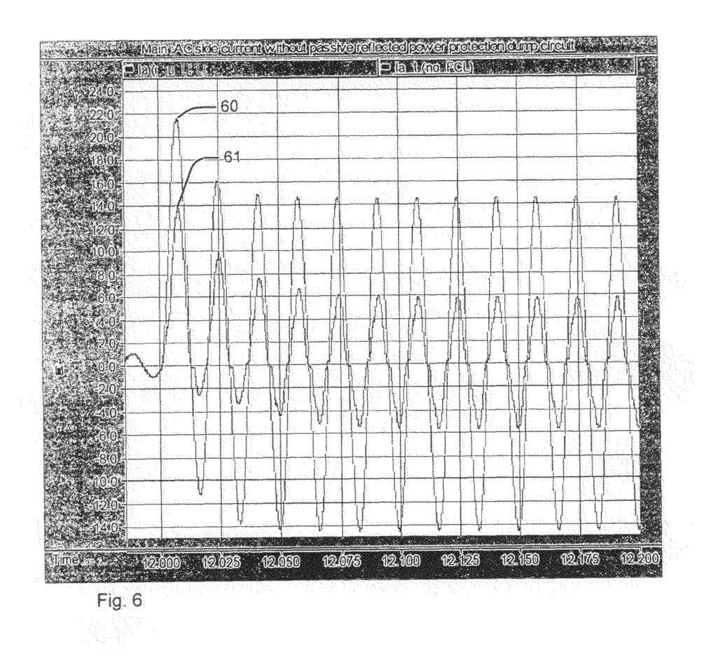

FIG. 6 illustrates the basic functional characteristics of the FCL. That is, the art described here does not effect the performance of the FCL, but rather enhances the protection and reliability of the DC circuit required for the correct and repeated operation of same. The graphs illustrate AC side current for a first case 60 where no FCL is present and a second case 61 where the FCL is present. The two plots show the reduction in the fault current when the DC saturated fault current limiter is employed in the AC circuit compared to the case when it is not employed.

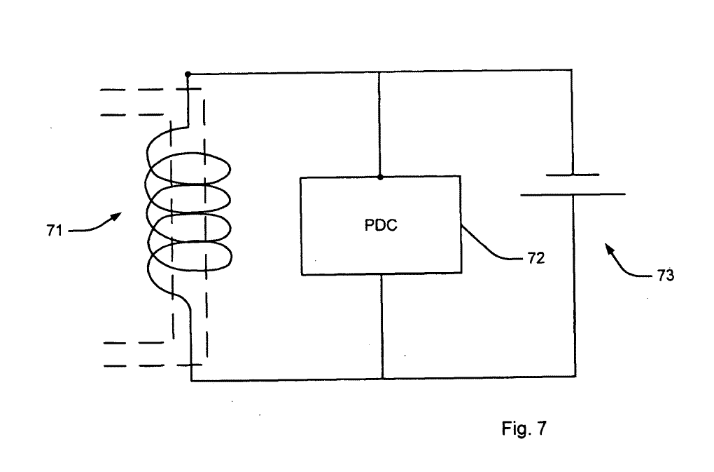

In the preferred embodiment, in addition to the FCL, a passively switched power dampening circuit is also included in parallel with the DC coil circuit, the arrangement being as illustrated schematically in FIG. 7, with the DC coil 71 formed around the steel core 74 and the Power Dampening Circuit 72 formed in parallel and interconnected to DC power source 73.

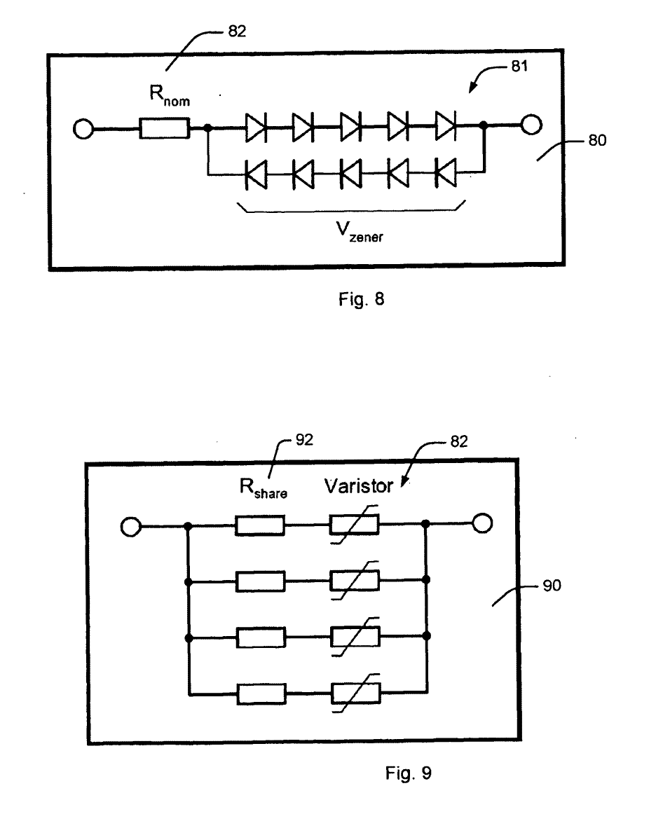

FIG. 8 illustrates a first form of passively switched power dampening circuit 80 and FIG. 9 illustrates a second form of circuit 90. Both include a passively switched dump resistor in the DC coil circuit. As noted previously, these circuits are connected in parallel with the superconducting coil.

Both circuits of FIG. 8 and FIG. 9 employ non-linear components which act as switches during transient events on the AC circuit. During the steady state, non-faulted condition, the protection circuits 80, 90 have an overall high impedance and do not conduct a current. Hence, these protection circuits do not impose any additional current burden on the DC power supply and have a zero thermal loading. This reduces the amount of heat sinking and cooling which may be otherwise required.

During a fault event on the AC circuit, the magnitude of the transient voltage across the DC coil 71 (FIG. 7) will increase to higher value than normal through mutual coupling between the AC and DC circuits. This voltage will trigger the passive switching elements (i.e. the varistors 81 or the diodes 82) to conduct and hence these components, if sized correctly, will have a low resistance during the fault period on the AC circuit.

It will be recognised that the ‘switch on’ voltage of the circuit shown in FIG. 8 can be tailored by adjusting the number of diodes 81 in each series string. In an alternative arrangement, the diodes 81 can be replaced by appropriately sized spark gap device or other passive device which switches on at a known forward bias voltage. Alternatively, where available the diode chain can be replaced by an appropriately rated Zener diode.

One advantage of the protection circuit shown in FIG. 8 is that the components do not have a transient thermal cooling time requirement before they can be next employed in a voltage limiting function. For example, some non-linear resistors derive their non-linear characteristics from a heating effect. The effect may require a cool down time which is not practical for overall device reliability. For example, circuit breaker logic at a particular sub-station may require the circuit breaker to close after a period of 1 second in order to “re-try” the circuit. This scheme is often used where overhead line feeders are used (i.e. not underground) and a fallen branch may be the cause of the short circuit.

The forward bias of the diodes 81 in FIG. 8 can be set to a value which is less than the over-voltage protection setting on the DC power supply 73 (FIG. 7). In this way, the power supply stays active during the AC side fault event and will be ready for the next subsequent AC fault event without any delay time to re-bias the core.

The choice of the dump resistor, R (82, 92), will depend on the components employed in the DC power supply and filter, the energy stored in the DC coil, and the voltage insulation to withstand the level of the de coil.

In the preferred embodiments the circuits applied are protecting a superconducting coil, and they are employed to dump energy from the coil that is reflected from the AC side of the circuit.

Those also skilled in the art will recognise that the circuits above may be replaced by employing an over-voltage detection circuit, an IGBT switch to isolate the power supply, and another IGBT switch to divert the DC coil energy and the reflected transient energy to a dump resistor. However, that type of protection mechanism relies on active detection techniques and electronics to be effective. The preferred embodiments provide a passive circuit, and are hence likely to be more robust, and is in keeping with the passive nature of the DC saturated fault current limiter.

There will now be proved an explanation of how the passive dampening circuits act to reduce the transient induced current and voltage waveforms

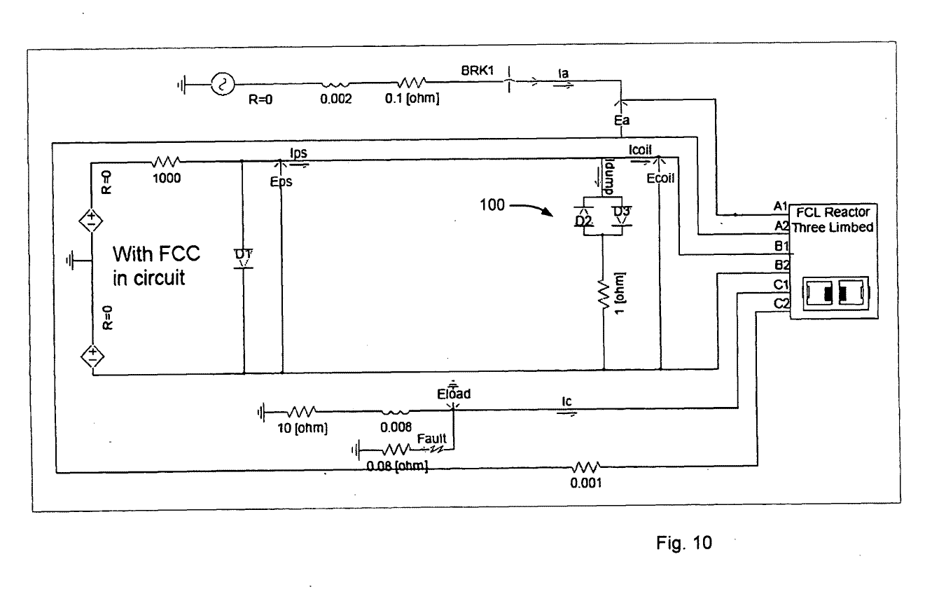

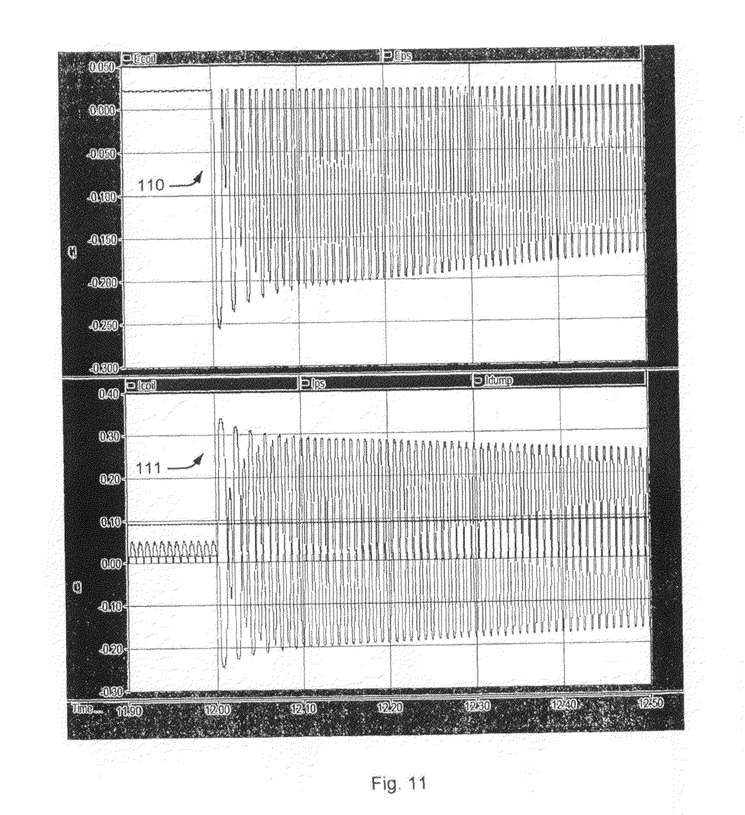

FIG. 10 shows the same circuit as in FIG. 4 but with the inclusion of a passive reflected-power dampening circuit 100. The forward bias of each of the diode strings 100 was set to 6.0 Volts by connecting ten diodes in series in each parallel string of diodes. This is the “turn on” voltage of the protection circuit. Other parameters pertaining the circuit were as follows: the number of AC turns was 40 on each of the six limbs (n=40); the number of DC turns was 800 (N=800); the DC bias current was 90 Amps, I(Power_Supply)=90 Amps; the AC voltage source employed was 11 to kV AC RMS line to line; the AC circuit load was 10 Ohms (Unfaultcd steady state load); the short circuit load (i.e. the fault impedance) employed was 0.08 Ohms; the prospective short circuit current was 10,000 Amps; the core area of permeable material was 0.02 square meters; the core window dimensions employed were 0.8 m wide×2.2 m high, and the time oldie fault occurring was designated t=12.000 seconds

FIG. 11 shows the calculated transient currents 111 and voltages 110 in the DC circuit after a fault event on the AC side. The induced voltage in the DC circuit has been effectively reduced to a peak of approximately 200 Volts and the DC current to a peak of approximately 300 Amps.

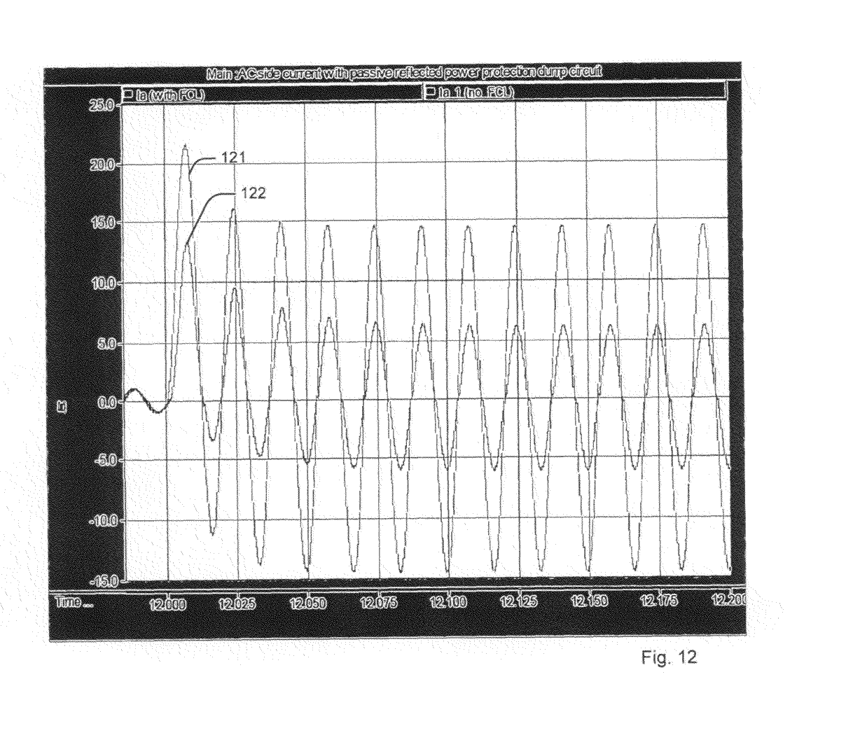

FIG. 12 shows the calculated AC circuit transient current waveforms for the circuit in FIG. 10, with 122 and without 121 an FCL. It can be seen that the FCL does not alter its main performance requirement with the protection circuit included. It will be apparent that the turn-on voltage and the resistance value can be altered to suit a particular power supply or DC coil design. For example, if a higher induced voltage level can be tolerated due to superior DC coil insulation, then the turn-on voltage can be increased by increasing the number of diodes placed in series in each string of diodes. The choice of the resistance R also needs to be balanced with the type of cooling employed for the superconducting coil. For example, a superconducting coil which is dry cooled, that is, by a cold head, in vacuum space, is less able to survive long transient heating periods. In this case, a better insulation of the superconducting coil can be employed, and a higher value of the dump resistance such that the energy is dumped in a reduced time period.

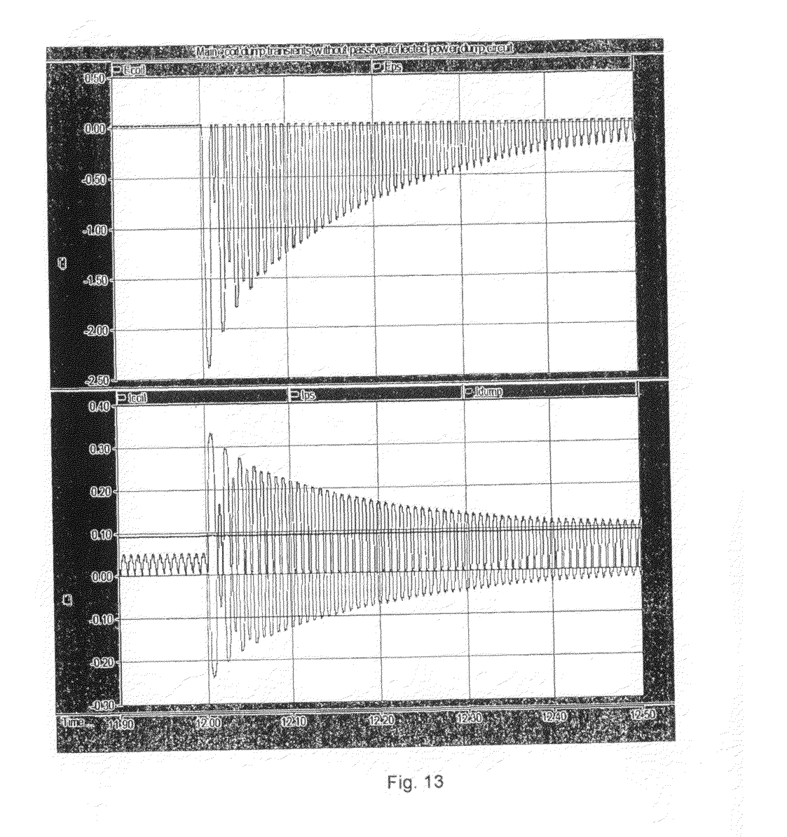

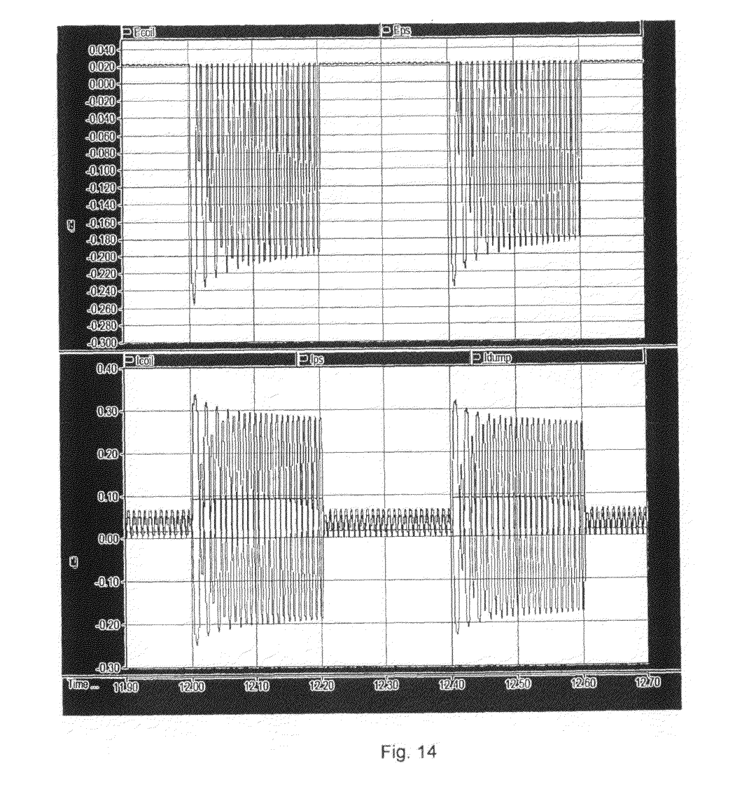

As a particular example of a suitable protection technique for a cold head cooled superconducting coil, FIG. 13 shows that the total energy can be dumped in a shorter period of time by increasing the dump resistance value at the expense of a higher maximum coil voltage induced into the DC circuit. In this calculation, the value of the dump resistance was increased to 10 Ohms and the turn on voltage of the protection diodes was kept at 6 Volts. The consequence is that the maximum voltage induced into the DC circuit increases to 2.5 kV, however, the period of time that the increased current flows is significantly reduced—by a factor of 10, due to the higher dump resistance value.

The value of R can be increased until the impulse insulation strength of the DC coil is approached. The choice of R must be balanced, however, with the thermal rating of the protection circuit components, the superconducting coil, and the heat sinks must be appropriately sized for the particular circuit.

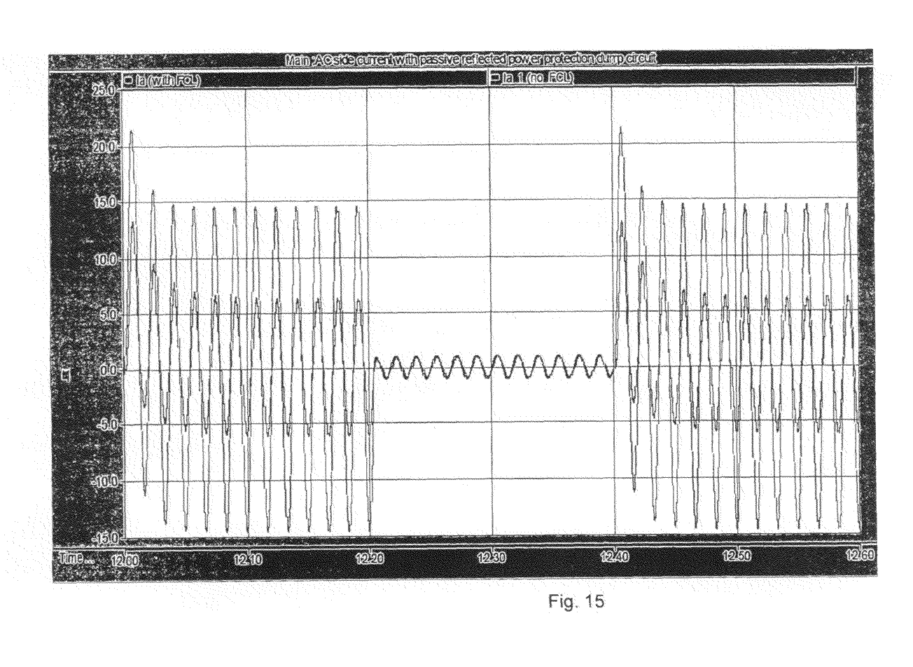

FIG. 14 and FIG. 15 show that the inclusion of the proposed protection circuits do not prevent the FCL from limiting faults which occur in close succession, for example, shortly after a circuit breaker re-close event on a persistent fault on the AC circuit.

It may also be recognised that the schemes posed here provide a means for including backup or redundancy of the protection. By adding one or more passive power dampening circuits in parallel across the DC coil, each designed and sized thermally and electrically to take the expected induced voltage and current, a redundant system is built. This would protect against burnt out components or other electrical faults in any one dump circuit.

It will be evident to those skilled in the art that the arrangement illustrated can be used in both single and multiphase systems. Although the invention has been described with reference to specific examples it will be appreciated by those skilled in the art that the invention may be embodied in many other forms.

1. A method of dampening a transient in a DC biasing coil in a fault current limiter, the method including the step of:
interconnecting a transient suppression circuit across the DC biasing coil, said transient suppression circuit being operative when the transient voltage across the DC biasing coil exceeds a predetermined maximum.

2. A method as claimed in claim 1, wherein said transient suppression circuit includes a series of cascaded diodes.

3. A method as claimed in claim 2, wherein said transient suppression circuit includes a first and second series of diodes connected in series, with the first and second series being connected in parallel with an opposite orientation to one another.

4. A method as claimed in claim 2 wherein said transient suppression circuit includes a resistor interconnected in series with the diodes.

5. A method as claimed in claim 1, wherein said transient suppression circuit includes a series of non-linear resistors.

6. A method as claimed in claim 1, wherein said transient suppression circuit includes a series of cascaded Zener diodes in series with a suitably sized linear resistor.

7. A method as claimed in claim 1, wherein said transient suppression circuit includes a series of back to back parallel cascaded diodes in series with a suitably sized linear resistor.

8. A method as claimed in claim 1 wherein the DC biasing coil is wrapped around a core of a single phase in a multiphase system.

9. A method as claimed in claim 1 wherein the DC biasing coil is wrapped around a core protecting multiple phases in a multiphase system.

10. A method as claimed in claim 1 wherein said DC biasing coil comprises a superconducting coil.

11. A power dampening circuit for interconnection in parallel with a DC biasing coil in a fault current limiter, the power dampening circuit having a non-linear response, having a high impedance to low voltages across the DC biasing coil and a low impedance to high voltages across the DC biasing coil.

12. A power dampening circuit as claimed in claim 11 wherein the circuit is formed from passive components.

13. A power dampening circuit as claimed in claim 11 wherein said circuit includes a first and second series of diodes connected in series, with the first and second series being connected in parallel with an opposite orientation to one another.

14. A power dampening circuit as claimed in claim 13 wherein said circuit includes a resistor interconnected in series with the diodes.

15. A power dampening circuit as claimed in claim 12 including at least one non-linear resistor.

16.-17. (canceled)
